(19) United States
(12) Patent Application Publication
(10) Pub. No.: US 2018/0132427 A1
(43) Pub. Date: May 17, 2018

(54) Crimper For Managing Plant Growth

(71) Applicant: Brian Richie Designs Incorporated, Newport Beach, CA (US)

(72) Inventor: Brian Ritchie, Laguna Beach, CA (US)

(21) Appl. No.: 15/812,442

(22) Filed: Nov. 14, 2017

Related U.S. Application Data
(60) Provisional application No. 62/422,554, filed on Nov. 15, 2016.

(51) Int. Cl. A01G 9/12

(52) U.S. Cl. CPC A01G 9/12

(57) ABSTRACT

A crimper for managing the growth of a plant by controlling the position of a branch of the plant over the course of the plant's growth. The crimper includes a shaping tool and a growth control member. The shaping tool includes a gripping section and may also include a handle section, wherein the gripping section includes a first member and a second member, wherein the first member and the second member are curved in the same direction. The growth control member is arranged for placement about the branch of the plant, wherein actuation of the shaping tool causes the first member and the second member to squeeze the growth control member into a fixed curved shape about the branch of the plant.

### BACKGROUND OF THE INVENTION

### 1. Field of the Invention

The present invention relates to devices for controlling the orientation of the growth of plants. More particularly, the present invention relates to tools for managing plant growth over the course of the growth period.

### 2. Description of the Prior Art

A common and desirable practice when growing plants including, but not limited to, cannabis, other than watering them, is to train the plants to grow in certain ways. That may be done by snipping off the top of the plant to promote new growth or to limit the plant's size. Some growers tie branches back to maximize the use of available sunlight and/or artificial light and to otherwise control the shape of the plant over the course of its growth. Growers also create a “screen of green” by building a structure that supports a screen into which the plant grows. The plants under the screen grow to the same height and so there is no one plant overshadowing its neighbors and thereby limiting their access to light. Regardless of the plant growth method or methods employed, we know that by “training” a plant, one can control the shape of the plant grown to take better advantage of available light, and ultimately, increase the yield of a plant as well as the yield of its neighbors.

A problem with training plants is that it is currently very labor intensive, and involves all sorts of awkward postures as the grower contorts himself/herself to gain access to areas of the plant. Imagine being on your hands and knees, tying pieces of string to branches, tying them down somehow without breaking them, and repeating the process multiple times per plant for as many plants as are being grown. The problem of fatigue, repetitive process injury and reduction in efficiency is magnified for a large-grow organization. What is needed is an apparatus to aid in the regulation of plant growth. What is needed is such an apparatus that can be used in a way that enhances plant growth management while avoiding or minimizing the adverse side effects experienced by the participants in the plant growth management activity.

### SUMMARY OF THE INVENTION

The present invention is a device that aids a grower in managing the growth of a plant. The device is referred to herein as a crimper. The crimper includes a shaping tool, a growth control member and an optional protective interface. The shaping tool has a handle section and a gripping section. The handle section has two handle members that can be manipulated to cause opening and closing of the gripping section. In an alternative embodiment of the invention, the handle section is not needed and, instead, the pressure is applied to the gripping section directly by hand of the user, in which the crimper operates something like a staple remover in that pressure may be applied directly by hand to opposing ends of the gripping section. The gripping section includes a first member and an opposing second member. The two members are curved at a selectable radius to establish a frame. The optional protective interface spans either or both of the first member and the second member of the gripping section of the shaping tool and can be used to minimize damage to a plant branch as the first member and second member of the shaping tool are actuated together about the branch. The growth control member is made of a material that is flexible enough to be manipulated into a selectable configuration by the shaping tool yet of sufficient structural integrity to maintain that selected configuration once removed from the shaping tool.

The shaping tool allows a grower to “train” plants by easily and safely bending the branches of those plants into a selectable position and maintaining that position as the plant grows. The user selects a branch to be trained and the area of the branch to bend to cause the branch to grow in a specific direction. The growth control member is applied about the branch at the selected area. The growth control member may be a sheet of Aluminum, wire mesh, a plastic sheet or other suitable material that retains its shape when shaped about the branch using the shaping tool. Once the growth control member has been applied to the branch, the shaping tool is positioned about the growth control member so that the first member and the second member of the gripping section are spaced apart from one another. The handles of the shaping tool are then actuated to close together to cause the first and second member of the gripping section to close together about the growth control member and, thereby, about the branch of the plant. The branch safely bends into a curved shape corresponding substantially to the curvature of the space between the first and second member.

The optional protective interface may be used as a cushion between the frame formed by the first and second member of the shaping tool. The protective interface is flexible and has sufficient give and elasticity to conform to the shape of the interior of the member to which it is connected when the first member and the second member are squeezed together. The protective interface may be made of rubber or flexible foam, for example, but not limited thereto.

Once the branch has been curved as desired, the handles are then opened to remove the pressure applied to the branch. The growth control member left in place on the branch retains the shape established when it was squeezed by the shaping tool. In doing so, it also maintains the curve of the plant branch in substantially the same way. In effect, the growth control member serves as a splint to hold the branch in place in the new shape. It also minimizes kinking. The growth control member can be removed when the plant is to be harvested and/or when a new shaping arrangement is desired or required. Removed growth control members may be recycled dependent on the material selected. Thus, one or a few shaping tools and potentially recyclable growth control members may be used to manage the growth of a plurality of plants and, as a result, maximize yield. The invention is further described in the accompanying drawings, detailed description and appended claims.

### BRIEF DESCRIPTION OF THE DRAWINGS

FIG. 1 is simplified front perspective view of the shaping tool of the crimper of the present invention.

FIG. 2 is a simplified front perspective view of a portion of the shaping tool of the crimper and a representation of a growth control member of the present invention.

FIG. 3 is a simplified perspective view of the crimper of the present invention positioned about a plant branch.

FIG. 4 is a simplified perspective view of the crimper of the present invention bending the branch.

FIG. 5 is a simplified view of the branch after bending with the growth control member in position about the branch.

### DETAILED DESCRIPTION OF THE INVENTION

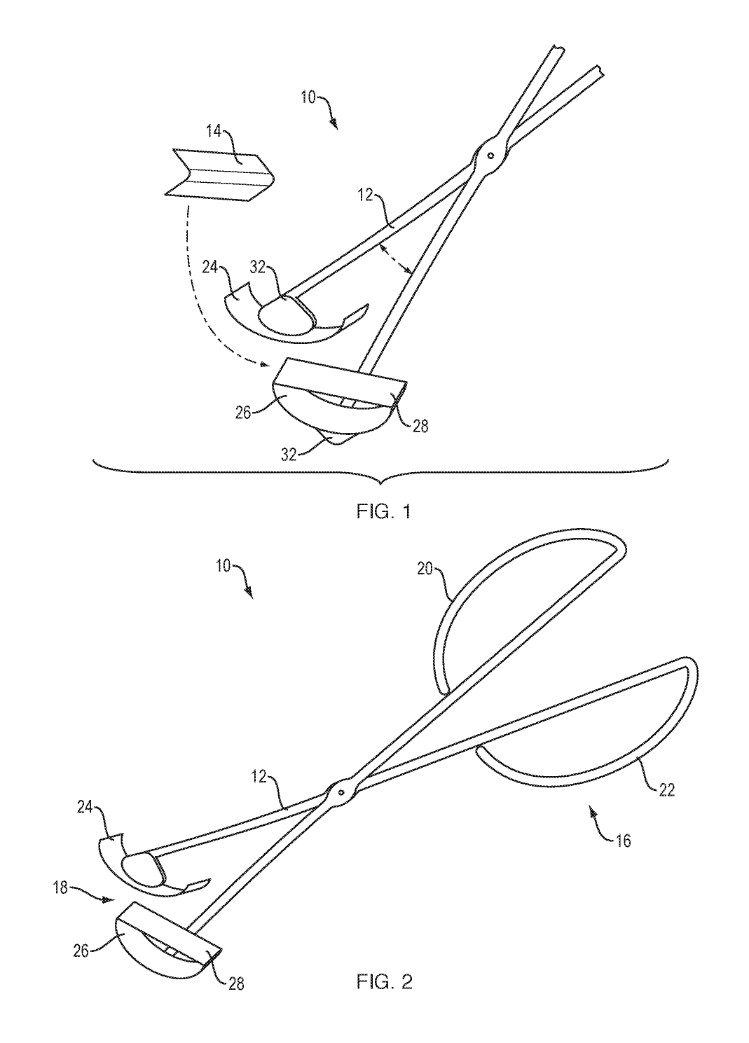

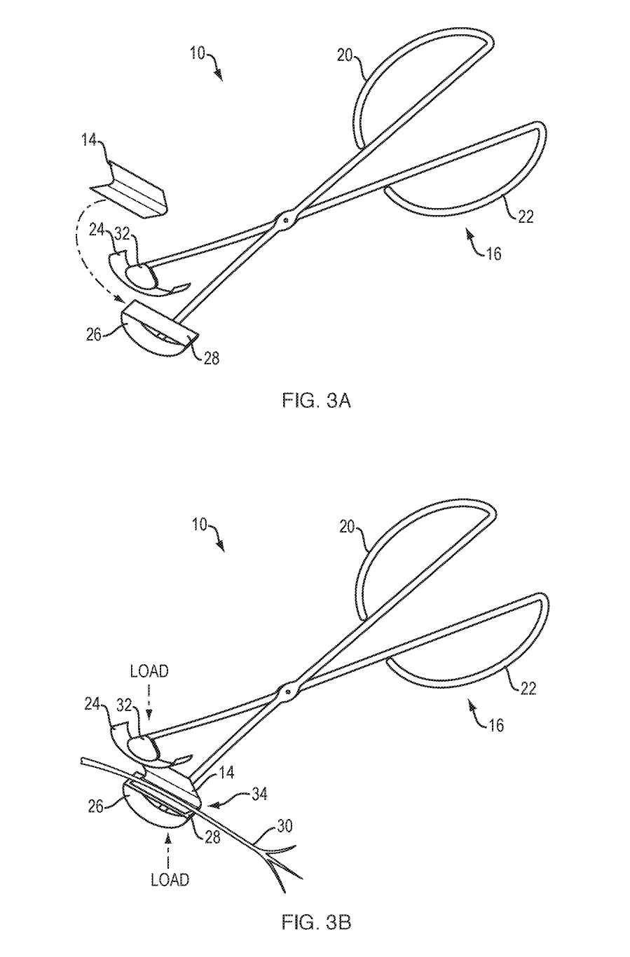

An embodiment of a crimper 10 of the present invention is shown in FIGS. 1-4. The crimper 10 includes a shaping tool 12 and a growth control member 14. The shaping tool 12 includes a handle section 16 and a gripping section 18. The handle section 16 has two handle members 20 and 22 that can be manipulated to cause opening and closing of the gripping section 18. The gripping section 18 includes a first member 24 and an opposing second member 26. The two members 24/26 are curved at a selectable radius to establish a frame. They may have the same radius of curvature or different radii of curvature. An optional protective interface 28 spans either or both of the first member 24 and the second member 26 of the gripping section 18 of the shaping tool 12 and can be used to minimize damage to a plant branch 30 as the first member 24 and the second member 26 of the shaping tool 12 are actuated together about the branch 30.

Each of the first member 24 and the second member 26 includes a structural body 32 that may be in the form of a wedge 32. The structural body is configured to maintain a sufficient loading force on the branch 30 when the members 24/26 are squeezed together on the branch 30. The shaping tool 12 may be made of metal or other material with sufficient structural integrity. The first member 24 and the second member 26 are curved in the same direction and they may be of the same or a different arc length. They may have the same radius of curvature or they may be different. The shaping tool 12 may be generally operated as a pair of scissors wherein the closing together of handle members 20 and 22 cause the first member 24 and the second member 26 to close in on anything located in the space between them, including the branch 30.

The growth control member 14 is made of a material that is flexible enough to be manipulated into a selectable configuration by the shaping tool 12 yet of sufficient structural integrity to maintain that selected configuration once load from the squeezed shaping tool 12 has been removed. It may be made into any desirable size but should generally wrap about the branch 30 and should be long enough to maintain the branch 30 at the desired bend. That length may be limited to the arc of either or both of the first member 24 and the second member 26 but is not limited thereto.

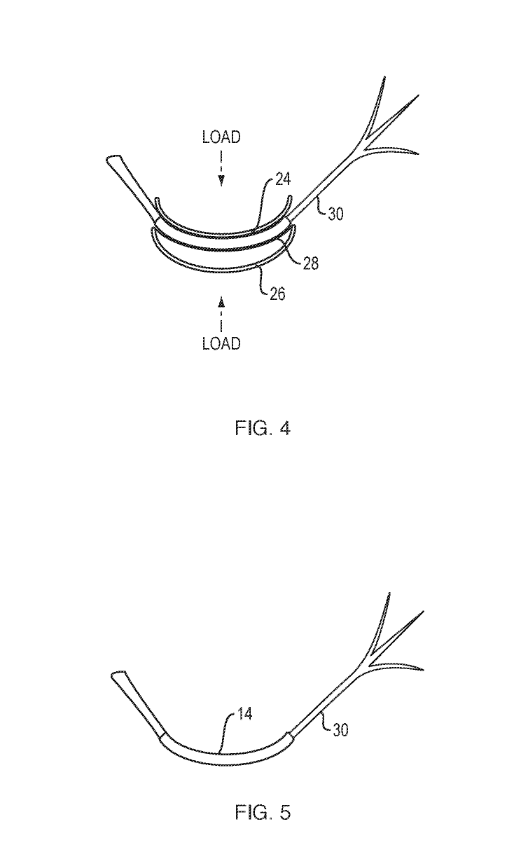

With respect to FIGS. 4 and 5, the shaping tool 12 allows a grower to “train” plants by easily and safely bending the branches of those plants into a selectable position and maintaining that position as the plant grows. The user selects the branch 30 to be trained and an area 34 of the branch 30 to bend to cause the branch to grow in a specific direction. The growth control member 14 is applied about the branch 30 at the selected area 34. The growth control member 14 may be a sheet of Aluminum, wire mesh, a plastic sheet or other suitable material that retains its shape when shaped about the branch using the shaping tool 12. Once the growth control member 14 has been applied to the branch 30, the shaping tool 12 is positioned about the growth control member 14 so that the first member 24 and the second member 26 of the gripping section 18 are spaced apart from one another. The handle members 20/22 of the shaping tool 12 are then actuated to close together to cause the first member 24 and the second member 26 of the gripping section 18 to close together about the growth control member 14 and, thereby, about the branch 30 of the plant. The branch 30 safely bends into a curved shape corresponding substantially to the curvature of the space between the first member 24 and the second member 26.

The optional protective interface 28 may be used as a cushion between the frame formed by the first member 24 and the second member 26 of the shaping tool 12. The protective interface 28 is flexible and has sufficient give and elasticity to conform to the shape of the interior of the member 24/26 to which it is connected when the first member 24 and the second member 26 are squeezed together. The protective interface 28 may be made of rubber or flexible foam, for example, but not limited thereto.

Once the branch 30 has been curved as desired, the handle members 20/22 are then opened to remove the pressure applied to the branch 30. The growth control member 14 left in place on the branch 30 retains the shape established when it was squeezed by the shaping tool 12, as shown in FIG. 5. In doing so, it also maintains the curve of the plant branch in substantially the same way. In effect, the growth control member 14 serves as a splint to hold the branch 30 in place in the new shape. It also minimizes kinking. The growth control member 14 can be removed when the plant is to be harvested and/or when a new shaping arrangement is desired or required. Used growth control members may be recycled dependent on the material selected. As a result, one or a few shaping tools and potentially recyclable growth control members may be used to manage the growth of a plurality of plants and, thus, maximize yield.

In an alternative embodiment of the invention, the handle section 16 is omitted and the user may actuate the gripping section 18 directly by hand, such as by squeezing together the first member 24 and the second member 26 together about the branch 30. In that regard, the gripping section 18 does not require the inclusion of the wedge 32 on the opposing first and second members 24/26, although it could be used. When this embodiment of the crimper 10, an option involves using a magnet to keep the growth control member 14 in position about the branch 30 in the desired location provided that the growth control member 14 chosen for the function is made of a ferromagnetic material, such as steel mesh for example. The magnet would be used to hold the growth control member 14 in place until such time as the user is ready to complete the crimping process.

The present invention has been described by specific examples, which examples are not intended to be limiting. Instead, the scope of the invention is defined in the following claims and its equivalents.

What is claimed is:

1. A crimper for managing the growth of a plant by controlling the position of a branch of the plant, the crimper comprising:
a. a shaping tool including a handle section and a gripping section, wherein the gripping section includes a first member and a second member, wherein the first member and the second member are curved in the same direction; and
c. a growth control member arranged for placement about the branch of the plant, wherein actuation of the shaping tool causes the first member and the second member to squeeze the growth control member into a fixed curved shape about the branch of the plant.

2. The crimper of claim 1 further comprising a flexible interface applied to one or both of the first member and the second member of the gripping section of the shaping tool.

3. The crimper of claim 1 wherein the first member and the second member are of different arc lengths.

4. The crimper of claim 1 wherein the growth control member is made of Aluminum foil or steel mesh.

5. A crimper for managing the growth of a plant by controlling the position of a branch of the plant, the crimper comprising:
a. a shaping tool including a gripping section, wherein the gripping section includes a first member and a second member, wherein the first member and the second member are curved in the same direction; and
c. a growth control member arranged for placement about the branch of the plant, wherein actuation of the shaping tool causes the first member and the second member to squeeze the growth control member into a fixed curved shape about the branch of the plant.

6. The crimper of claim 5 further comprising a flexible interface applied to one or both of the first member and the second member of the gripping section of the shaping tool.

7. The crimper of claim 5 wherein the first member and the second member are of different arc lengths.

8. The crimper of claim 5 wherein the growth control member is made of Aluminum foil or steel mesh.
